(19) United States
(12) Patent Application Publication
(10) Pub. No.: US 2023/0237454 A1
(43) Pub. Date: Jul. 27, 2023

(54) SYSTEM AND METHOD FOR NFT PATRONAGE WITH MONITORING, ELECTRONIC DISPLAY, AND REVERSIONARY FUNDING

(71) Applicant: 28c Partners LLC, Bronxville, NY (US)

(72) Inventors: Francesco Rulli, Bronxville, NY (US); Thomas Courtney, Bronxville, NY (US)

(21) Appl. No.: 17/581,799

(22) Filed: Jan. 21, 2022

(51) Int. Cl. G06Q 20/12; H04L 9/32; G06Q 20/36

(52) U.S. Cl. CPC G06Q 20/1235; H04L 9/3213; G06Q 20/367; H04L 2209/60

(57) ABSTRACT

A system is provided for the generation and management of Non-Fungible Tokens (NFTs) for supporting an institution is provided. The system has a processor for generating at least one NFT, the NFT being associated with at least one artwork. The NFT includes at least a first set of coding identifying the at least one artwork, at least a second set of coding setting a first allocation of funds from an initial sale of said NFT to a first patron to said institution for said at least one artwork; and at least a third set of coding setting a second allocation of funds from a subsequent sale of the NFT, by a first patron to a second patron, to the institution for the at least one artwork. The NFT is configured to be sellable on an ongoing basis, such that for each subsequent sale of the NFT from the purchase by the second patron, and including all subsequent purchases by additional patrons, results in at least a portion of the subsequent sales being diverted to the institution.

### FIELD OF THE INVENTION

The present arrangement relates to a system and method for securing patronage of an artwork. More particularly, the present arrangement relates to a system and method for securing continued patronage of an artwork, along with an associated display of patron information.

### DESCRIPTION OF RELATED ART

In the field of artwork patronage, many institutions act as conservators of works of art, such as museums and galleries. The preservation and maintenance of works of art, particularly older works of art is a tedious and expensive endeavor requiring a great deal of funding. In many cases a museum will have fundraisers and other funding drives to collect money for the preservation of works. In some cases, particularly with valuable works and/or collections, a particular patron will donate to the institution to fund its preservation. In exchange the museum will typically display some form of acknowledgment of the patron next to the work or collection to honor their donation. This entire process of securing funding can be difficult and time consuming for the museum, taking up valuable time and resources.

Recently with developments in blockchain technology, the art world has been attracting the use of NFT (Non-Fungible Tokens). An NFT is essentially a cryptographically secured asset, using blockchain technology, that is fixedly associated with either a digital or real-world asset. A first example would be a digital asset such as a digital image secured to an NFT. In this case the NFT holder would own the “original” version of the digital asset (secured to the NFT). The digital art itself could be reproduced in a fungible manner, but the original NFT is not reproducible or fungible. The NFT owner would own the original as a non-fungible asset that they could hold and/or sell. In another example, an NFT can be created for a physical object, such as a statue or other physical object. The NFT itself would identify the asset and otherwise be an “original” digital version of the asset that could be bought and sold as an original digital representation of the physical asset. The NFTs are equivalent to certificates of authenticity for digital artifacts.

### OBJECTS AND SUMMARY

The present arrangement includes a system that generates NFTs relating to market sales as a way to assign patronage to a physical asset to raise and secure funding for an artwork or collection of artworks. As part of the arrangement, in one example, an institution can generate an NFT associated with an artwork that requires upkeep and maintenance. The sale of the NFT can be used to raise funds for the artwork and associate the work with its patron, automatically updating an electronic display located near the artwork at the institution, essentially providing exclusive naming/patron rights to the original NFT purchaser. Additionally, in one embodiment, the NFT can be encoded such that subsequent sales of the NFT on the secondary market would allow the institution to earn a portion of subsequent sales as a continuing source of funding for the maintenance of the corresponding artwork. Moreover, the NFT coding can be such that subsequent sales can likewise be used to automatically update the naming of the patronage on the associated digital display located next to the work so that the current patronage NFT owner can be reflected near the artwork.

Various permutations can be implemented using this system and method to obtain additional funding for upkeep of the artwork when the original patron decides to resell its NFT such as issuing second and/or subsequent NFTs and listing additional patron's name(s) on the display. Such arrangements can also be implemented as charitable donation to possibly make the NFT purchases tax deductible.

To this end, a system for the generation and management of Non-Fungible Tokens (NFTs) for supporting an institution is provided. The system has a processor for generating at least one NFT, the NFT being associated with at least one artwork. The NFT includes at least a first set of coding identifying the at least one artwork, at least a second set of coding setting a first allocation of funds from an initial sale of said NFT to a first patron to said institution for said at least one artwork; and at least a third set of coding setting a second allocation of funds from a subsequent sale of the NFT, by a first patron to a second patron, to the institution for the at least one artwork.

The NFT is configured to be sellable on an ongoing basis, such that for each subsequent sale of the NFT from the purchase by the second patron, and including all subsequent purchases by additional patrons, results in at least a portion of the subsequent sales being diverted to the institution.

### BRIEF DESCRIPTION OF DRAWINGS

The present invention can be best understood through the following description and accompanying drawing, wherein:

FIG. 1 is diagram of the system for NFT generation and tracking, along with the associated marketplace, patrons, and institution, in accordance with one embodiment;

FIG. 2 is a diagram of the NFT structure in accordance with one embodiment;

FIG. 3 is a flow diagram of the generation and sale of an NFT to an initial patron, in accordance with one embodiment;

FIG. 4 is diagram of an institution and updated display indicating an initial patron for an artwork in accordance with one embodiment;

FIG. 5 is a flow diagram of the generation and sale of an NFT to a subsequent patron, in accordance with one embodiment; and

FIG. 6 is a diagram of an institution and updated display indicating a subsequent patron for an artwork in accordance with one embodiment.

### DETAILED DESCRIPTION

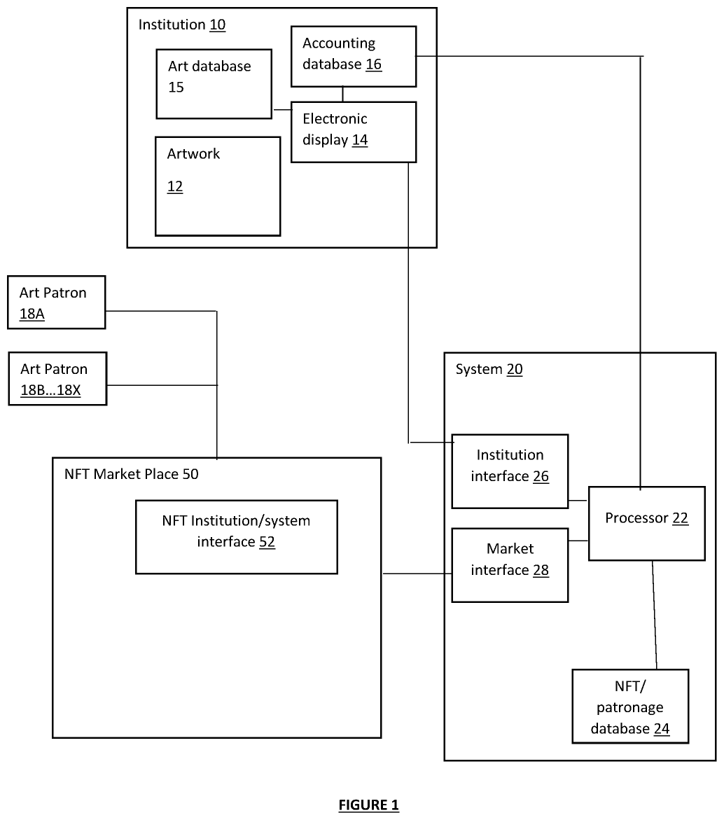

In one embodiment as shown in FIG. 1, an art institution 10 is shown, which in the present example is a museum or other art gallery. In such an institution, a plurality of artwork 12 is on display, each item (or collection thereof) can have an associated electronic display 14 that may or may not have some information about the artwork, but also display information about a patron or patrons that have donated to the preservation and upkeep of the artwork 10 as explained below. Institution 10 likewise maintains at least one accounting database 16 that among other things, accounts for how much money has been donated by a patron or patron(s) to support each particular artwork 12 that is subject to the present system.

It is understood that the present arrangement is described in conjunction with art museums as institutions 10 for describing the salient features of the invention. However, such an arrangement with similar features may be used as a system for pledging money against objects using the same technical features in other fields of interest including but not limited to any arrangement requiring pledged monetary upkeep from a patron and having some acknowledgement of the patron associated therewith.

As shown in FIG. 1, system 20 is shown for generating an NFT associated with an artwork 12 at the request of institution 10. As shown, system 20 is an independent arrangement from institution 10 but it is understood that system 20 may also be implemented as an entirely in-house operation of institution 10. System 20 maintains a processor 22 for generating and maintaining the functionality of an NFT, as well as database 24 for maintaining any required associated records required to support the creation, coding, maintenance, and tracking of any NFTs. The process for generating the NFT (NFT 100) is described in more detail below. An institution interface 26 is included with system 20 to communicate with accounting database 16 of institution 10. System 20 may also include a market interface 28 for communicating with a NFT marketplace 50 which supports the transactions of NFTs. For example, NFT marketplace 50 and system/institution interface 52 can either be a separately constructed marketplace 50 for supporting the market of available NFTs and facilitating the transactions. The marketplace 50 is illustrated in FIG. 1 as an independent entity, but it is understood that marketplace 50 could be implemented internally with system 20 and/or within institution 10 if a private marketplace/secondary marketplace is desired.

FIG. 1 further illustrates a plurality of art patrons 18A-18X that interact through marketplace 50 to purchase and/or sell NFTs in accordance with the procedures outlined below.

In another embodiment an exemplary block diagram of an NFT 100, generated by system 20, is shown with the relevant features and code fields for supporting salient features of the present invention. For example, NFT 100 may maintain a basic NFT name field 102 that would include an identifier for NFT 100 as well as some basic data to identify the associated artwork, the type of patronage being supported (e.g. restoration, maintenance, education about the work etc. . . . ) and possibly other basic data required for identification and tracking.

NFT 100 also maintains a NFT coding block 104 that includes all necessary blockchain coding required for NFT 100, including but not limited to coding for the NFT 100 itself, transactional and hash coding, origin block coding, and any other such coding required to manage NFT initial transactions in marketplace 50. Block 104 also includes the coding for digital artwork itself. For example, as noted above NFT 100 may be associated with a particular artwork 12. In that case, NFT 100 may include a high-resolution digital image or images of artwork 12 (possibly before and after restoration, different views etc. . . . ), and other associated data about the work. Such data is coded into the primary NFT coding block 104. Additionally, as explained above and in more detail below, block 104 includes any necessary coding for divisional of initial sales proceeds to be directed to institution 10.

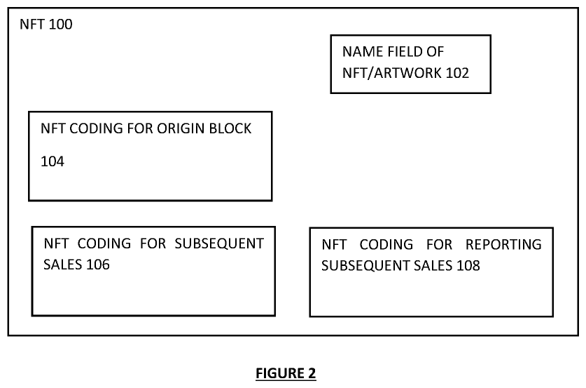

FIG. 2 also illustrates NFT coding block(s) 106 required for expanding the blockchain as subsequent sales are recorded. Moreover, as explained above, and in more detail below, block 106 includes the necessary coding for division of subsequent sales proceeds between the selling patron 18 of NFT 100 and institution 10. For example, in one basic situation, when an initial patron 18 sells NFT 100 to a subsequent patron 18 some percentage of the money is sent to the selling patron 18 and some other percentage is sent to institution 10. A full description of such options is explained in the subsequent flow charts and examples. NFT 100 also maintains a coding block 108 that includes coding required to transmit ownership data of NFT 100 to institution 10 to update electronic display 14 next to artwork 12 to show one or more owners of relevant NFTs 100 corresponding to that particular artwork 12.

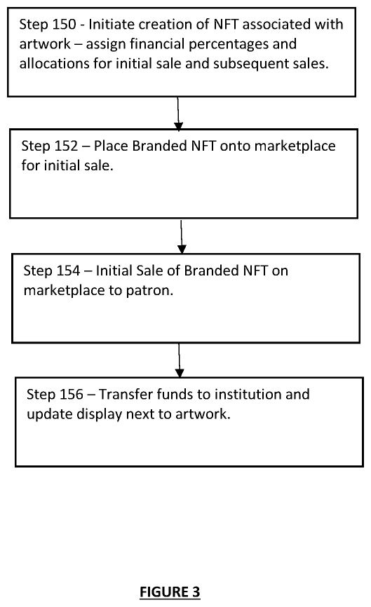

Turning to an exemplary process of the present arrangement, FIG. 3 shows the steps for generation and initial sale of NFT 100. At step 150, institution 10 selects an artwork 12 for which they are seeking to generate an NFT 100. At this stage institution 10 may set their funding parameters for how the NFT proceeds are used for artwork 12 from both the initial sale as well as subsequent sales. In one basic example, institution 10 may set a goal that 100% of the initial sale is for the restoration and maintenance of an artwork 12 and that every subsequent sale diverts an additional 10% back to institution 10 for the same purpose. Other more detailed allocations are explained hereinafter as alternate examples, but for the purposes of explaining the basic allocation functions, this exemplary arrangement is used. This information is sent to system 20 to generate NFT 100 accordingly. As explained above, NFT 100 may include one or more digital representations or images of artwork 12 associated therewith.

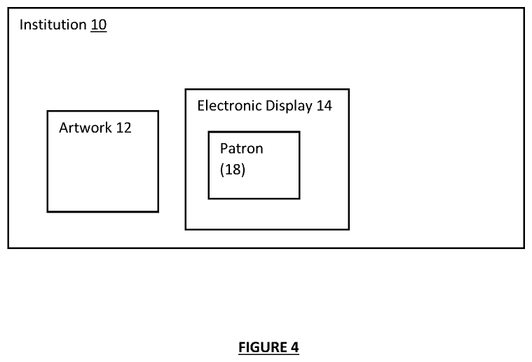

At step 152, once NFT 100 is created it is placed onto marketplace 50 for sale or auction to patrons 18. At step 154, once the price is set and patron 18 makes the payment, marketplace 50 collects the purchase price and sends the sale information and funds to system 20. At step 156 system 20 transfers the funds from the sale to the institution to be applied as per the terms of NFT 100 which in this case is 100% for the restoration and maintenance of art 12 associated with NFT 100, accounted for in accounting database 16. System 20 further delivers the name ownership/information of patron 18 to institution 10 for display on electronic display 14 next to artwork 12 to which NFT 100 relates. It is noted that display 14 may include in addition to the name of patron 18, other details related to artwork 12 including the name of the restorer/restoring institution or other relevant information about the project funded by NFT 100. See for example FIG. 4. It is noted that data about patron 18 contained in display 14 may also be shared with a institution database 15 so that such information can be shared an updated into more general information about artwork 12 such as being included in web information about the art, inclusion in walking tour information, and the like.

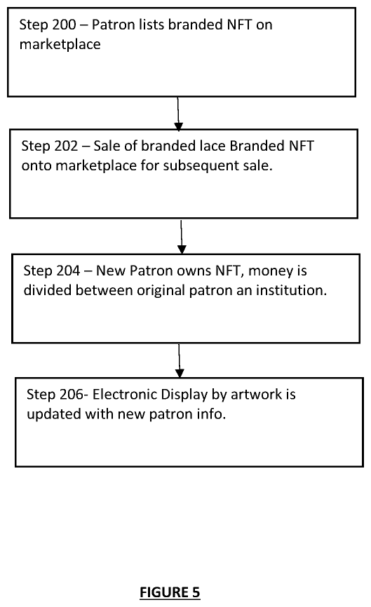

Turning to FIG. 5 showing an exemplary secondary sale of NFT 100, at step 200 patron 18 that owns NFT 100 may place it on marketplace 50 to be sold or auctioned to potential new patrons 18. At step 202 after a final price is set, marketplace 50 handles the transaction of NFT 100 between original patron 18 and new patron 18 and collects the funds.

At step 204, after the transaction, marketplace 50 delivers the transaction information and funds to system 20 to be divided according to the instructions in block 108. In the present example, 10% of the transaction costs is diverted to be delivered to institution 10 to be associated with the patronage of artwork 12 connected to NFT 100. The remaining money is retained by selling patron 18.

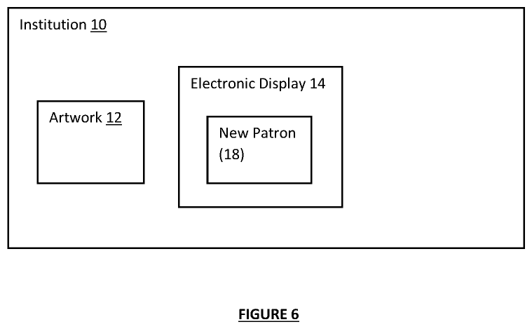

It is understood that exact logistics of the funds distribution can be handled at either marketplace 50 and/or system 20. For example, if marketplace 50 can handle the transaction, and NFT 100 coding, it can simply retain the portion for selling patron 18 for immediately delivery and only send the reserve portion to system 20 for transfer to institution. Additionally, how the 10% diversion to institution is apportioned between selling patron 18 and buying patron 18 can be adjusted to be 10% from seller, 10% extra for buyer, split 5%/5% etc. . . . depending on how NFT 100 coding is arranged (which would be visible on marketplace 50 prior to transaction so all parties would know in advance). At step 206 once the transaction is complete, system 20 transfers collected funds for institution 10 for application as additional patronage against artwork 12 and also receives the information to update the name with the new patron 18 on electronic display 14 as shown in FIG. 6 (either adding or replacing the prior name 18 depending on the terms of NFT 100). This process in FIG. 5 can be repeated for additional subsequent purchases of NFT 100 using essentially the same steps. In one possible alternative electronic display 14 can list multiple patrons 18 include prior owners and the present owners of NFT 100. Other options for NFT may also include the ability to “lease” NFT 100 to patron 18 instead of providing an outright sale/ownership transfer so as to allow more flexible patronage options for future issuances to protect an artwork 12 (i.e. NFTs 100 may be sold as one year leases so that they can either be renewed or institution 10 can simply re-sell the next increment lease to maintain continuous funding)

Based on the above, a system and method is provided for using NFTs 100 to generate a patronage platform for the support of institution 10 and artwork 12. Not only can institution 10 take advantage of NFT functionality to collect and allocate funds from the generation and sale of NFT 100 to a patron 18, but it can also generate continued patronage revenue from subsequent sales to new patrons 18. Moreover, the present system and method also can have patron 18 information automatically updated and displayed digitally next to supported artwork 14.

It is noted that there are many variations available on the specific implementation of the inventive system and method, particularly with respect to the manner in which institution 10 allocates funds received from this arrangement. For example, in the example, NFT 100 is coded that 100% of the sale of the initial NFT is directed to restoration/maintenance of an artwork 12. However, the same system and method may be used to generate an NFT 100 that is coded to direct 20% to restoration/maintenance of an artwork 12, but also indicate to patron 18 that other percentages of initial purchase can be used for other institutional purposes such as 50% to the institution endowment, 20% to maintenance, and 10% to ongoing education about artwork 12. Obviously, institution 10 may set whatever percentage allocations they want in NFT 100 coding that they believe will be desirable on the part of patrons 18. Additionally, in the above example, subsequent purchases divert 10% of future sales back to institution 10 for continued additional support of artwork 12. However, institution 10 may adjust the percentage higher or lower depending on the expected needs for supporting artwork 12, and may choose to allocate that additional money either according to the same initial percentages applied to the first sale or possibly according to a different scaling (e.g. first sale allocated more towards restoration, but with revenue from subsequent sales be allocated more towards maintenance).

In another example, the coding in blocks 104, 106 and 108 of NFT 100 can be arranged to provide patron 18 (and holder of NFT 100) with certain reserve rights. For example, NFT 100 may be offered at an initial price to patrons 18 on marketplace 50 for lower introduction price, for example for $5000, primarily for restoration. The sale of this NFT 100 would result in patron 18 being displayed as “restoration patron” on electronic display (either near artwork 12 or a wall acknowledging works under restoration). However, NFT 100 may also be coded such that when restoration is complete, NFT 100 is to be reissued as a separate and distinct NFT such as NFT 100R (restored) when this restored artwork 12 is being placed back on display post restoration. Coding in NFT 100 may be set such that original patron 18 is given access to NFT 100R for free, or with a right to buy option. If original purchasing patron 18 desires, they can pay an additional sum for ownership of NFT 100R and to be updated on electronic display 14 as provider of maintenance and education about artwork 12. If they refuse, NFT 100R can be returned to the general marketplace 50 along the lines outlined above. With the programable language capabilities of NFT 100 (or NFT 100R) in code blocks 104, 106, and 108 there are many possible permutations that can be implanted within the context of the present system and method.

Other examples of options concerning the issuance of NFT 100 may include, but are not limited to: the ability to present/display NFTs 100 prior to sale, i.e. for display reasons; the ability to fragment NFT 100 and sell it in a fragmented form, for example sell only 1% of an NFT 100 to potentially multiple patrons 18; the ability to license/lease NFT 100 (ie similar to licensing images for book publishers); and the ability to NFT 100 an artificial intelligence related to artwork 12, attaching to it all the benefit of the AI that improves in time (For example www.michelangelotalk.com, an artwork related AI that answers with questions/intents can be supported by a patron 18).

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for the generation and management of Non-Fungible Tokens (NFTs) for supporting an institution, said system comprising:
a processor for generating at least one NFT, said NFT associated with at least one artwork, wherein said NFT includes
at least a first set of coding identifying said at least one artwork,
at least a second set of coding setting a first allocation of funds from an initial sale of said NFT to a first patron to said institution for said at least one artwork; and
at least a third set of coding setting a second allocation of funds from a subsequent sale of said NFT, by a first patron to a second patron, to said institution for said at least one artwork,
wherein said NFT is configured to be sellable on an ongoing basis, such that for each subsequent sale of said NFT from said purchase by said second patron, and including all subsequent purchases by additional patrons, results in at least a portion of said subsequent sales being diverted to said institution.

2. The system as claimed in claim 1, wherein said system is configured to provide data to said institution to provide an identifier associated with said first patron, such that an electronic display associated with said artwork can be updated with information about said first patron.

3. The system as claimed in claim 2, wherein said system is configured to provide data to said institution to provide an identifier associated with said second patron, such that an electronic display associated with said artwork can be updated with information about said second patron.

4. The system as claimed in claim 3, wherein said system is configured to provide data to said institution to provide an identifier associated with said first and second patron, as well as all said additional patrons such that an electronic display associated with said artwork can be updated with information about said first and second patrons as well as all said additional patrons.

5. The system as claimed in claim 1, wherein said NFT includes at least one digital representation of said artwork.

6. The system as claimed in claim 1, wherein said system is configured to generate said NFT for sale to said first patron, with a second said of coding to allocate funds to said intuition for a restoration of said artwork, and wherein said system upon completion of said restoration of said artwork issues a second restored NFT for the same said artwork.

7. The system as claimed in claim 6, wherein said system is configured to offer said second restored NFT to said first patron.
